(19) United States
(12) Patent Application Publication
(10) Pub. No.: US 2023/0203411 A1
(43) Pub. Date: Jun. 29, 2023

(54) UNIT DOSE PRODUCT COMPRISING A LIQUID COMPOSITION WITH ENCAPSULATED FRAGRANCE

(71) Applicant: Henkel IP & Holding GmbH, Duesseldorf (DE)

(72) Inventors: Wei Sun, Trumbull, CT (US); Jessica Eileen McKeon, Trumbull, CT (US); Yichen Deng, Boston, MA (US)

(21) Appl. No.: 17/564,980

(22) Filed: Dec. 29, 2021

(51) Int. Cl. C11D 17/04; C11D 3/00; C11D 3/50; C11D 3/37; C11D 3/43; C11D 3/30; C11D 11/00; C11D 17/00

(52) U.S. Cl. CPC C11D 17/043; C11D 3/0047; C11D 3/505; C11D 3/3707; C11D 3/43; C11D 3/30; C11D 11/0017; C11D 17/0017; C11D 11/0094

(57) ABSTRACT

The present disclosure provides the a fabric treatment unit dose product comprising at least one water-soluble compartment enclosing a liquid composition; wherein the liquid composition comprises an encapsulated fragrance slurry, a rheology modifier, a pH adjusting agent, a first non-aqueous solvent, a second a non-aqueous solvent, and a polyethylene glycol.

### FIELD OF DISCLOSURE

The present disclosure relates to unit dose compositions comprising at least one water-soluble compartment enclosing a liquid composition.

### BACKGROUND

Encapsulated fragrances are useful due to their ability to create long-lasting fragrance on fabrics. Encapsulated fragrances require water to remain intact and suspended in their formulations. This poses a challenge when formulating for unit dose products, which are enclosed in a water-soluble film. Liquids in unit dose products need to have low water activity to avoid dissolving the film prematurely. When encapsulated fragrances are mixed with film-compatible solvents such as polyethylene glycol, fragrance encapsulations agglomerate to form large particles that do not dissolve when added to wash liquor.

Some solvents such as glycerin and propylene glycol do not cause high levels of encapsulations agglomeration, but formulations show phase separation within 8 hours, which prohibits standard processing strategies. Different combinations of these solvents have different separation times, but all separate within hours. Thus, there is a need for a formula that both stabilizes the encapsulated fragrances and minimizes film interactions without compromising dissolution.

### BRIEF SUMMARY

In some aspects, provided herein is a fabric treatment unit dose product comprising at least one water-soluble compartment enclosing a liquid composition. In some aspects, the liquid composition comprises from about 10% by weight to about 70% by weight of an encapsulated fragrance slurry; from about 0.15% by weight to about 1.2% by weight of a rheology modifier; from about 0.1% by weight to about 3% by weight of a pH adjusting agent; from about 5% by weight to about 40% by weight of a first non-aqueous solvent; from about 0% by weight to about 20% by weight of a second a non-aqueous solvent; and from about 10% by weight to about 60% by weight of a polyethylene glycol.

In some aspects, provided herein is a liquid composition comprising from about 10% by weight to about 70% by weight of an encapsulated fragrance slurry; from about 0.15% by weight to about 1.2% by weight of an rheology modifier; from about 0.1% by weight to about 3% by weight of a pH adjusting agent; from about 5% by weight to about 40% by weight of a first non-aqueous solvent; from about 0% by weight to about 20% by weight of a second a non-aqueous solvent; and from about 10% by weight to about 60% by weight of a polyethylene glycol.

In some aspects, provided herein is a fabric treatment unit dose product comprising at least one water-soluble compartment enclosing a liquid composition. In some aspects, the liquid composition comprises from about 10% by weight to about 70% by weight of an encapsulated fragrance slurry; from about 0.15% by weight to about 1.2% by weight of a rheology modifier; from about 0.1% by weight to about 3% by weight of a pH adjusting agent; from about 5% by weight to about 40% by weight of a first non-aqueous solvent; from about 1% by weight to about 20% by weight of a second non-aqueous solvent; and from about 10% by weight to about 60% by weight of a polyethylene glycol.

In some aspects, the polyethylene glycol has a molecular weight between about 200 and about 1000 Daltons.

In some aspects, the rheology modifier is an acrylic copolymer, an Alkali Soluble Emulsion (ASE) or a Hydrophobically Modified Alkali Soluble Emulsion (HASE) polymer.

In some aspects, the polyethylene glycol has a molecular weight of about 400 Daltons.

In some aspects, the pH adjusting agent is selected from the group consisting of triethanolamine, monoethanolamine, tromethamine, sodium carbonate, sodium bicarbonate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), and tetrasodium glutamate diacetate (GLDA).

In some aspects, the pH adjusting agent is triethanolamine.

In some aspects, the first non-aqueous solvent is selected from the group consisting of ethylene glycol, glycerin, ethanol, dipropylene glycol, and tripropylene glycol methyl ether. In some aspects, the second non-aqueous solvent is propylene glycol.

In some aspects, the rheology modifier is an Alkali Soluble Emulsion (ASE) or a Hydrophobically Modified Alkali Soluble Emulsion (HASE) polymer.

In some aspects, the liquid composition does not separate into more than one layer for at least one week at room temperature.

### BRIEF DESCRIPTION OF DRAWINGS

FIG. 1 shows the separation index of a reference formula and a liquid composition as disclosed herein as measured by a lumisizer test (2000 rpm for 3000 seconds).

FIGS. 2A-2B show phase separation of the reference formula and as compared to a liquid composition as disclosed herein. FIG. 2A shows the phase separation of the reference formula (left) as compared to a liquid composition as disclosed herein (right) after being aged for 4 weeks at room temperature. FIG. 2B shows the phase separation of the reference formula (left) as compared to a liquid composition as disclosed herein (right) after being aged for 4 weeks at 40° C.

FIG. 3 shows the separation index of a liquid composition as disclosed herein with or without alcohol ethoxylate (C25-7) as measured by a lumisizer test at 500 seconds or 3000 seconds.

FIG. 4 shows the separation index of a liquid composition as disclosed herein with or without propylene glycol as measured by a lumisizer test with two different encapsulated fragrances (Maxwell and Forcefield).

FIG. 5A-5B show the visual representation of the smoothness of the liquid with or without propylene glycol.

### DETAILED DESCRIPTION

Provided herein is a fabric treatment unit dose product comprising at least one water-soluble compartment enclosing a liquid composition. In some aspects, the fabric treatment unit dose product comprises at least one water-soluble compartment enclosing a liquid composition; wherein the liquid composition comprises an encapsulated fragrance slurry, a rheology modifier, a pH adjusting agent, a first non-aqueous solvent, optionally a second a non-aqueous solvent, and a polyethylene glycol.

Non-limiting examples of the various aspects are shown in the present disclosure.

### I. Definitions

In order that the present disclosure can be more readily understood, certain terms are first defined. Additional definitions are set forth throughout the detailed disclosure.

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Furthermore, “and/or”, where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

Open terms such as “include,” “including,” “contain,” “containing” and the like mean “comprising.” The term “or” can be conjunctive or disjunctive.

It is understood that wherever aspects are described herein with the language “comprising,” otherwise analogous aspects described in terms of “consisting of” and/or “consisting essentially of” are also provided.

Some inventive embodiments contemplate numerical ranges. Every numerical range provided herein includes the range endpoints as individual inventive embodiments. When a numerical range is provided, all individual values and sub-ranges therein are present as if explicitly written out.

The term “about” includes the recited number±10%. For example, “about 10” means 9 to 11.

The phrase “substantially free of” means that a composition contains little no specified ingredient/component, such as less than about 5% by weight, less than about 4% by weight, less than about 3% by weight, less than about 2% by weight, or less than about 1% by weight of the specified ingredient.

As used herein, the “%” described in the present application refers to the weight percentage unless otherwise indicated. The term “at least” prior to a number or series of numbers is understood to include the number adjacent to the term “at least,” and all subsequent numbers or integers that could logically be included, as clear from context. For example, “at least one non-aqueous solvent” means that 1, 2, 3, or more non-aqueous solvents have the indicated property. When at least is present before a series of numbers or a range, it is understood that “at least” can modify each of the numbers in the series or range. “At least” is also not limited to integers (e.g., “at least 5%” includes 5.0%, 5.1%, 5.18% without consideration of the number of significant figures).

Unless states otherwise, the term “by weight of the composition” refers to a composition of a final product derived from a process, unless otherwise defined.

The terms “textile” and “fabric” can be used interchangeably.

The terms “fragrance” and “perfume” can be used interchangeably.

The terms “capsule”, “microcapsule”, and “encapsulate” can be used interchangeably.

The terms “process” and “method” can be used interchangeably.

The term “fragrance encapsulate” refers a core-shell structure which comprises a microcapsule (shell) and a fragrance (core) entrapped in the microcapsule. The weight of a fragrance encapsulate is the sum of the weight of the microcapsule and the weight of the fragrance (core) entrapped in the microcapsule.

The term “encapsulate fragrance slurry” refers a core-shell structure which comprises a microcapsule (shell) and a fragrance (core) entrapped in the microcapsule and the water and other ingredients that compose a commercially available fragrance encapsulate slurry. The weight of a encapsulate fragrance slurry is the sum of the weight of the microcapsule, the weight of the fragrance (core) entrapped in the microcapsule, the weight of the water and the weight of the other ingredients.

The term “encapsulated fragrance” refers a fragrance entrapped in the microcapsule. The weight of an encapsulated fragrance is the weight of the fragrance entrapped in the microcapsule, not including the weight of the microcapsule.

As used herein, “rheology modifier” refers to a compound or mixture of compounds that provide either a sufficient yield stress or low shear viscosity to stabilize the non-aqueous gel independently from, or extrinsic from, the structuring effect of any detersive surfactants in the gel. The rheology modifier used in the present invention is an alkali-soluble emulsion (ASE) polymer or a hydrophobically-modified alkali-soluble emulsion (HASE) polymer. A variety of HASE and ASE polymers are known in the art and are commercially available. Preferably, the rheology modifier is a copolymer comprising or consisting of acrylic acid monomer units and alkyl acrylate monomer units.

### Unit Dose Product

In some aspects, provided herein is a fabric treatment unit dose product comprising at least one water-soluble compartment enclosing a liquid composition. In some aspects, the liquid composition comprises from about 10% by weight to about 70% by weight of an encapsulated fragrance slurry; from about 0.15% by weight to about 1.2% by weight of a rheology modifier; from about 0.1% by weight to about 3% by weight of a pH adjusting agent; from about 5% by weight to about 40% by weight of a first non-aqueous solvent; from about 0% by weight to about 20% by weight of a second a non-aqueous solvent; and from about 10% by weight to about 60% by weight of a polyethylene glycol.

In some aspects, provided herein is a fabric treatment unit dose product comprising at least one water-soluble compartment enclosing a liquid composition. In some aspects, the liquid composition comprises from about 10% by weight to about 70% by weight of an encapsulated fragrance slurry; from about 0.15% by weight to about 1.2% by weight of a rheology modifier; from about 0.1% by weight to about 3% by weight of a pH adjusting agent; from about 5% by weight to about 40% by weight of a first non-aqueous solvent; from about 1% by weight to about 20% by weight of a second non-aqueous solvent; and from about 10% by weight to about 60% by weight of a polyethylene glycol.

In some aspects, provided herein is a liquid composition comprising from about 10% by weight to about 70% by weight of an encapsulated fragrance slurry; from about 0.15% by weight to about 1.2% by weight of an rheology modifier; from about 0.1% by weight to about 3% by weight of a pH adjusting agent; from about 5% by weight to about 40% by weight of a first non-aqueous solvent; from about 0% by weight to about 20% by weight of a second a non-aqueous solvent; and from about 10% by weight to about 60% by weight of a polyethylene glycol.

In some aspects, the polyethylene glycol has a molecular weight between about 200 and about 1000 Daltons.

In some aspects, provided herein is a liquid composition comprising from about 10% by weight to about 80% by weight of an encapsulated fragrance slurry. In some aspects, provided herein is a liquid composition comprising from about 20% by weight to about 70% by weight of an encapsulated fragrance slurry. In some aspects, provided herein is a liquid composition comprising from about 20% by weight to about 60% by weight of an encapsulated fragrance slurry. In some aspects, provided herein is a liquid composition comprising from about 20% by weight to about 50% by weight of an encapsulated fragrance slurry. In some aspects, provided herein is a liquid composition comprising from about 20% by weight to about 40% by weight of an encapsulated fragrance slurry. In some aspects, provided herein is a liquid composition comprising from about 20% by weight to about 30% by weight of an encapsulated fragrance slurry. In some aspects, provided herein is a liquid composition comprising from about 30% by weight to about 70% by weight of an encapsulated fragrance slurry. In some aspects, provided herein is a liquid composition comprising from about 40% by weight to about 70% by weight of an encapsulated fragrance slurry. In some aspects, provided herein is a liquid composition comprising from about 50% by weight to about 70% by weight of an encapsulated fragrance slurry. In some aspects, provided herein is a liquid composition comprising from about 60% by weight to about 70% by weight of an encapsulated fragrance slurry. In some aspects, provided herein is a liquid composition comprising from about 30% by weight to about 40% by weight of an encapsulated fragrance slurry.

In some aspects, the liquid composition comprises about 10% by weight, about 20% by weight, about 30% by weight, about 40% by weight, about 50% by weight, about 60% by weight, about 70% by weight, about 80% by weight or a range between any two of the preceding values of an encapsulated fragrance slurry. In some aspects, the liquid composition comprises about 40% by weight of an encapsulated fragrance slurry.

In some aspects, the encapsulated fragrance liquid slurry comprises from about 20% by weight to about 40% by weight of microcapsules. In some aspects, the encapsulated fragrance liquid slurry comprises from about 25% by weight to about 40% by weight of microcapsules. In some aspects, the encapsulated fragrance liquid slurry comprises from about 30% by weight to about 40% by weight of microcapsules. In some aspects, the encapsulated fragrance liquid slurry comprises from about 35% by weight to about 40% by weight of microcapsules. In some aspects, the encapsulated fragrance liquid slurry comprises from about 20% by weight to about 35% by weight of microcapsules. In some aspects, the encapsulated fragrance liquid slurry comprises from about 20% by weight to about 30% by weight of microcapsules. In some aspects, the encapsulated fragrance liquid slurry comprises from about 20% by weight to about 25% by weight of microcapsules. In some aspects, the encapsulated fragrance liquid slurry comprises from about 25% by weight to about 35% by weight of microcapsules.

In some aspects, the encapsulated fragrance liquid slurry comprises about 20% by weight, about 25% by weight, about 30% by weight, about 35% by weight, about 40% by weight, or a range between any two of the preceding values of microcapsules.

In some aspects, the microcapsules comprises a shell. In some aspects, the shell encapsulates a core material. In some aspects, the core material of the microcapsules includes one or more perfume oils. In some aspects, the shell of the microcapsules is made from synthetic polymeric materials or naturally-occurring polymers. The microcapsules may be any kind of microcapsule disclosed herein or known in the art. In some aspects, the synthetic polymers are derived from petroleum oil, for example. Non-limiting examples of synthetic polymers include nylon, polyethylenes, polyamides, polystyrenes, polyisoprenes, polycarbonates, polyesters, polyureas, polyurethanes, polyureaurethane, polyolefins, polysaccharides, epoxy resins, vinyl polymers, polyacrylates, gelatin, shellac, water insoluble inorganics, silicone, and mixtures thereof. Natural polymers occur in nature and may often be extracted from natural materials. Non-limiting examples of naturally occurring polymers are silk, wool, gelatin, cellulose, proteins, and combinations thereof.

In some aspects, the mean particle size of microcapsules is between about 1 to about 100 microns. In some aspects, the mean particle size of microcapsules is between about 5 to about 100 microns. In some aspects, the mean particle size of microcapsules is between about 10 to about 100 microns. In some aspects, the mean particle size of microcapsules is between about 20 to about 100 microns. In some aspects, the mean particle size of microcapsules is between about 30 to about 100 microns. In some aspects, the mean particle size of microcapsules is between about 40 to about 100 microns. In some aspects, the mean particle size of microcapsules is between about 50 to about 100 microns. In some aspects, the mean particle size of microcapsules is between about 60 to about 100 microns. In some aspects, the mean particle size of microcapsules is between about 70 to about 100 microns. In some aspects, the mean particle size of microcapsules is between about 80 to about 100 microns. In some aspects, the mean particle size of microcapsules is between about 90 to about 100 microns. In some aspects, the mean particle size of microcapsules is between about 1 to about 90 microns. In some aspects, the mean particle size of microcapsules is between about 1 to about 80 microns. In some aspects, the mean particle size of microcapsules is between about 1 to about 70 microns. In some aspects, the mean particle size of microcapsules is between about 1 to about 60 microns. In some aspects, the mean particle size of microcapsules is between about 1 to about 50 microns. In some aspects, the mean particle size of microcapsules is between about 1 to about 40 microns. In some aspects, the mean particle size of microcapsules is between about 1 to about 30 microns. In some aspects, the mean particle size of microcapsules is between about 1 to about 20 microns. In some aspects, the mean particle size of microcapsules is between about 1 to about 10 microns. In some aspects, the mean particle size of microcapsules is between about 1 to about 5 microns.

In some aspects, the mean particle size of microcapsules is about 1 micron, about 5 microns, about 10 microns, about 20 microns, about 30 microns, about 40 microns, about 50 microns, about 60 microns, about 70 microns, about 80 microns, about 90 microns, about 100 microns, or a range between any two of the preceding values.

In some aspects, the rheology modifier is an acrylic copolymer, an Alkali Soluble Emulsion (ASE) polymer or a Hydrophobically Modified Alkali Soluble Emulsion (HASE) polymer.

In some aspects, the rheology modifier is a HASE polymer. In some aspects, the HASE polymer has the following structure:

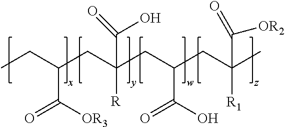

wherein R, R₁ and R₃ are independently selected from H and alkyl groups, wherein R₂ is an optionally alkoxylated alkyl group, and wherein w, x, y and z are integers.

In some aspects, R, R₁ and R₃ are independently selected from C₁-C₁₀ alkyl groups, R₂ is an ethoxylated C₁-C₂₀ alkyl group and R₃ is selected from H and C₁-C₆ alkyl groups. In some aspects, R and R₁ are methyl groups, R₂ is an ethoxylated C₈-C₂₀ alkyl group and R₃ is an ethyl group. In some aspects, the repeating units comprising R, R₁, R₂ and R₃ can be in any suitable order, or even randomly distributed through the polymer chain.

In some aspects, the HASE polymer can have a molecular weight of between about 50,000 to about 500,000 g/mol, between about 80,000 to about 400,000 g/mol, between about 100,000 to about 300,000 g/mol, between about 50,000 to about 450,000 g/mol, between about 50,000 to about 400,000 g/mol, between about 50,000 to about 350,000 g/mol, between about 50,000 to about 300,000 g/mol, between about 50,000 to about 250,000 g/mol, between about 50,000 to about 200,000 g/mol, between about 50,000 to about 150,000 g/mol, between about 50,000 to about 100,000 g/mol, between about 100,000 to about 500,000 g/mol, between about 150,000 to about 500,000 g/mol, between about 200,000 to about 500,000 g/mol, between about 250,000 to about 500,000 g/mol, between about 300,000 to about 500,000 g/mol, between about 350,000 to about 500,000 g/mol, between about 400,000 to about 500,000 g/mol, or between about 450,000 to about 500,000 g/mol. In some aspects, the HASE polymer has a molecular weight of about 50,000 g/mol, about 80,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, about 500,000 g/mol, or a range between any two of the preceding values.

In some aspects, the ratio of x:y is between 1:20 to 20:1, between 1:10 to 10:1, or between 1:5 to 5:1. In some aspects, the ratio of x:w is between 1:20 to 20:1, between 1:10 to 10:1, or between 1:5 to 5:1. In some aspects, the ratio of x:z can be between 1:1 to 500:1, between 2:1 to 250:1, or between 25:1 to 75:1.

Methods of making such HASE polymer are described in U.S. Pat. Nos. 4,514,552, 5,192,592, British Patent No. 870,994, and U.S. Pat. No. 7,217,443, all of which are incorporated herein by reference.

In some aspects, the rheology modifier is an ASE polymer. In some aspects, the ASE polymer has the following structure:

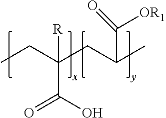

wherein R is selected from H and alkyl groups and R₁ is an alkyl group, and wherein x and y are integers.

In some aspects, R is selected from H and C₁-C₂₀ alkyl groups and R₁ is a C₁-C₂₀ alkyl group.

In some aspects, the ratio of x:y is between 1:20 to 20:1, between 1:10 to 10:1, or between 1:5 to 5:1. In some aspects, the ratio of x:w is between 1:20 to 20:1, between 1:10 to 10:1, or between 1:5 to 5:1. In some aspects, the ratio of x:z is between 1:1 to 500:1, between 2:1 to 250:1, or between 25:1 to 75:1.

In some aspects, the ASE polymer has a molecular weight of between 50,000 to 500,000 g/mol, between 80,000 to 400,000 g/mol, between 100,000 to 300,000 g/mol, between about 50,000 to about 450,000 g/mol, between about 50,000 to about 400,000 g/mol, between about 50,000 to about 350,000 g/mol, between about 50,000 to about 300,000 g/mol, between about 50,000 to about 250,000 g/mol, between about 50,000 to about 200,000 g/mol, between about 50,000 to about 150,000 g/mol, between about 50,000 to about 100,000 g/mol, between about 100,000 to about 500,000 g/mol, between about 150,000 to about 500,000 g/mol, between about 200,000 to about 500,000 g/mol, between about 250,000 to about 500,000 g/mol, between about 300,000 to about 500,000 g/mol, between about 350,000 to about 500,000 g/mol, between about 400,000 to about 500,000 g/mol, or between about 450,000 to about 500,000 g/mol. In some aspects, the ASE polymer has a molecular weight of about 50,000 g/mol, about 80,000 g/mol, about 100,000 g/mol, about 150,000 g/mol, about 200,000 g/mol, about 250,000 g/mol, about 300,000 g/mol, about 350,000 g/mol, about 400,000 g/mol, about 450,000 g/mol, about 500,000 g/mol, or a range between any two of the preceding values.

In some aspects, the liquid composition comprises from about 0.05% by weight to about 2.0% by weight of a rheology modifier. In some aspects, the liquid composition comprises from about 0.1% by weight to about 1.5% by weight of a rheology modifier. In some aspects, the liquid composition comprises from about 0.15% by weight to about 1.2% by weight of a rheology modifier. In some aspects, the liquid composition comprises from about 0.2% by weight to about 1.2% by weight of a rheology modifier. In some aspects, the liquid composition comprises from about 0.3% by weight to about 1.2% by weight of a rheology modifier. In some aspects, the liquid composition comprises from about 0.4% by weight to about 1.2% by weight of a rheology modifier. In some aspects, the liquid composition comprises from about 0.5% by weight to about 1.2% by weight of a rheology modifier. In some aspects, the liquid composition comprises from about 0.6% by weight to about 1.2% by weight of a rheology modifier. In some aspects, the liquid composition comprises from about 0.7% by weight to about 1.2% by weight of a rheology modifier. In some aspects, the liquid composition comprises from about 0.8% by weight to about 1.2% by weight of a rheology modifier. In some aspects, the liquid composition comprises from about 0.9% by weight to about 1.2% by weight of a rheology modifier. In some aspects, the liquid composition comprises from about 1.0% by weight to about 1.2% by weight of a rheology modifier. In some aspects, the liquid composition comprises from about 1.1% by weight to about 1.2% by weight of a rheology modifier. In some aspects, the liquid composition comprises from about 0.15% by weight to about 1.1% by weight of a rheology modifier. In some aspects, the liquid composition comprises from about 0.15% by weight to about 1.0% by weight of a rheology modifier. In some aspects, the liquid composition comprises from about 0.15% by weight to about 0.9% by weight of a rheology modifier. In some aspects, the liquid composition comprises from about 0.15% by weight to about 0.8% by weight of a rheology modifier. In some aspects, the liquid composition comprises from about 0.15% by weight to about 0.7% by weight of a rheology modifier. In some aspects, the liquid composition comprises from about 0.15% by weight to about 0.6% by weight of a rheology modifier. In some aspects, the liquid composition comprises from about 0.15% by weight to about 0.5% by weight of a rheology modifier. In some aspects, the liquid composition comprises from about 0.15% by weight to about 0.4% by weight of a rheology modifier. In some aspects, the liquid composition comprises from about 0.15% by weight to about 0.3% by weight of a rheology modifier. In some aspects, the liquid composition comprises from about 0.15% by weight to about 0.2% by weight of a rheology modifier. In some aspects, the liquid composition comprises about 0.05% by weight, about 0.1% by weight, about 0.15% by weight, about 0.2% by weight, about 0.3% by weight, about 0.4% by weight, about 0.5% by weight, about 0.6% by weight, about 0.7% by weight, about 0.8% by weight, about 0.9% by weight, about 1.0% by weight, about 1.1% by weight, about 1.2% by weight, about 1.3% by weight, about 1.4% by weight, about 1.5% by weight, or a range between any two of the preceding values of a rheology modifier. In some aspects, the liquid composition comprises about 0.6% by weight of a rheology modifier.

In some aspects, the liquid composition comprises from about 5% by weight to about 70% by weight of a polyethylene glycol. In some aspects, the liquid composition comprises from about 10% by weight to about 60% by weight of a polyethylene glycol. In some aspects, the liquid composition comprises from about 20% by weight to about 60% by weight of a polyethylene glycol. In some aspects, the liquid composition comprises from about 20% by weight to about 50% by weight of a polyethylene glycol. In some aspects, the liquid composition comprises from about 25% by weight to about 50% by weight of a polyethylene glycol. In some aspects, the liquid composition comprises from about 30% by weight to about 50% by weight of a polyethylene glycol. In some aspects, the liquid composition comprises from about 35% by weight to about 50% by weight of a polyethylene glycol. In some aspects, the liquid composition comprises from about 40% by weight to about 50% by weight of a polyethylene glycol. In some aspects, the liquid composition comprises from about 45% by weight to about 50% by weight of a polyethylene glycol. In some aspects, the liquid composition comprises from about 20% by weight to about 45% by weight of a polyethylene glycol. In some aspects, the liquid composition comprises from about 20% by weight to about 40% by weight of a polyethylene glycol. In some aspects, the liquid composition comprises from about 20% by weight to about 35% by weight of a polyethylene glycol. In some aspects, the liquid composition comprises from about 20% by weight to about 30% by weight of a polyethylene glycol. In some aspects, the liquid composition comprises from about 20% by weight to about 25% by weight of a polyethylene glycol.

In some aspects, the liquid composition comprises about 5% by weight, about 10% by weight, about 15% by weight, about 20% by weight, about 25% by weight, about 30% by weight, about 35% by weight, about 40% by weight, about 45% by weight, about 50% by weight, about 55% by weight, about 60% by weight, about 65% by weight, about 70% by weight, about 75% by weight, about 80% by weight, or a range between any of two the preceding values of a polyethylene glycol. In some aspects, the liquid composition comprises about 35% by weight of a polyethylene glycol.

In some aspects, the polyethylene glycol has a molecular weight between about 200 and about 1000 Daltons. In some aspects, the polyethylene glycol has a molecular weight between about 300 and about 1000 Daltons. In some aspects, the polyethylene glycol has a molecular weight between about 400 and about 1000 Daltons. In some aspects, the polyethylene glycol has a molecular weight between about 500 and about 1000 Daltons. In some aspects, the polyethylene glycol has a molecular weight between about 600 and about 1000 Daltons. In some aspects, the polyethylene glycol has a molecular weight between about 700 and about 1000 Daltons. In some aspects, the polyethylene glycol has a molecular weight between about 800 and about 1000 Daltons. In some aspects, the polyethylene glycol has a molecular weight between about 900 and about 1000 Daltons. In some aspects, the polyethylene glycol has a molecular weight between about 200 and about 900 Daltons. In some aspects, the polyethylene glycol has a molecular weight between about 200 and about 800 Daltons. In some aspects, the polyethylene glycol has a molecular weight between about 200 and about 700 Daltons. In some aspects, the polyethylene glycol has a molecular weight between about 200 and about 600 Daltons. In some aspects, the polyethylene glycol has a molecular weight between about 200 and about 500 Daltons. In some aspects, the polyethylene glycol has a molecular weight between about 200 and about 400 Daltons. In some aspects, the polyethylene glycol has a molecular weight between about 200 and about 300 Daltons. In some aspects, the polyethylene glycol has a molecular weight between about 300 and about 500 Daltons. In some aspects, the polyethylene glycol has a molecular weight between about 200 and about 400 Daltons. In some aspects, the polyethylene glycol has a molecular weight between about 400 and about 1000 Daltons.

In some aspects, the polyethylene glycol has a molecular weight of about 200 Daltons, about 300 Daltons, about 400 Daltons, about 500 Daltons, about 600 Daltons, about 700 Daltons, about 800 Daltons, about 900 Daltons, about 1000 Daltons, or a range between any two of the preceding values. In some aspects, the polyethylene glycol has a molecular weight of about 400 Daltons.

In some aspects, the pH adjusting agent is selected from the group consisting of triethanolamine, monoethanolamine, tromethamine, sodium carbonate, sodium bicarbonate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), and tetrasodium glutamate diacetate (GLDA).

In some aspects, the pH adjusting agent is triethanolamine. In some aspects, the pH adjusting agent creates a slightly alkaline environment for the rheology modifier to swell and form a structure. In some aspects, the structure maintains stable encapsulated fragrance suspension.

In some aspects, the liquid composition comprises from about 0.01% by weight to about 5% by weight of a pH adjusting agent. In some aspects, the liquid composition comprises from about 0.05% by weight to about 4% by weight of a pH adjusting agent. In some aspects, the liquid composition comprises from about 0.1% by weight to about 3% by weight of a pH adjusting agent. In some aspects, the liquid composition comprises from about 0.2% by weight to about 3% by weight of a pH adjusting agent. In some aspects, the liquid composition comprises from about 0.3% by weight to about 3% by weight of a pH adjusting agent. In some aspects, the liquid composition comprises from about 0.4% by weight to about 3% by weight of a pH adjusting agent. In some aspects, the liquid composition comprises from about 0.5% by weight to about 3% by weight of a pH adjusting agent. In some aspects, the liquid composition comprises from about 1.0% by weight to about 3% by weight of a pH adjusting agent. In some aspects, the liquid composition comprises from about 1.5% by weight to about 3% by weight of a pH adjusting agent. In some aspects, the liquid composition comprises from about 2.0% by weight to about 3% by weight of a pH adjusting agent. In some aspects, the liquid composition comprises from about 2.5% by weight to about 3% by weight of a pH adjusting agent. In some aspects, the liquid composition comprises from about 0.1% by weight to about 2.5% by weight of a pH adjusting agent. In some aspects, the liquid composition comprises from about 0.1% by weight to about 2% by weight of a pH adjusting agent. In some aspects, the liquid composition comprises from about 0.1% by weight to about 1.5% by weight of a pH adjusting agent. In some aspects, the liquid composition comprises from about 0.1% by weight to about 1% by weight of a pH adjusting agent. In some aspects, the liquid composition comprises from about 0.1% by weight to about 0.5% by weight of a pH adjusting agent. In some aspects, the liquid composition comprises from about 0.1% by weight to about 0.4% by weight of a pH adjusting agent. In some aspects, the liquid composition comprises from about 0.1% by weight to about 0.3% by weight of a pH adjusting agent. In some aspects, the liquid composition comprises from about 0.1% by weight to about 0.2% by weight of a pH adjusting agent.

In some aspects, the liquid composition comprises about 0.01% by weight, about 0.1% by weight, about 0.2% by weight, about 0.3% by weight, about 0.4% by weight, about 0.5% by weight, about 1% by weight, about 1.5% by weight, about 2% by weight, about 2.5% by weight, about 3% by weight, about 3.5% by weight, about 4% by weight, about 4.5% by weight, about 5% by weight, or a range between any two of the preceding values of a pH adjusting agent. In some aspects, the liquid composition comprises about 0.8% of a pH adjusting agent.

In some aspects, the first non-aqueous solvent is selected from the group consisting of ethylene glycol, glycerin, propylene glycol, ethanol, dipropylene glycol, and tripropylene glycol methyl ether. In some aspects, the first non-aqueous solvent is glycerin.

In some aspects, the liquid composition comprises from about 3% by weight to about 40% by weight of a first non-aqueous solvent. In some aspects, the liquid composition comprises from about 5% by weight to about 30% by weight of a first non-aqueous solvent. In some aspects, the liquid composition comprises from about 8% by weight to about 30% by weight of a first non-aqueous solvent. In some aspects, the liquid composition comprises from about 10% by weight to about 30% by weight of a first non-aqueous solvent. In some aspects, the liquid composition comprises from about 15% by weight to about 30% by weight of a first non-aqueous solvent. In some aspects, the liquid composition comprises from about 20% by weight to about 30% by weight of a first non-aqueous solvent. In some aspects, the liquid composition comprises from about 25% by weight to about 30% by weight of a first non-aqueous solvent. In some aspects, the liquid composition comprises from about 8% by weight to about 25% by weight of a first non-aqueous solvent. In some aspects, the liquid composition comprises from about 8% by weight to about 20% by weight of a first non-aqueous solvent. In some aspects, the liquid composition comprises from about 8% by weight to about 15% by weight of a first non-aqueous solvent. In some aspects, the liquid composition comprises from about 8% by weight to about 10% by weight of a first non-aqueous solvent.

In some aspects, the liquid composition comprises about 3% by weight, about 5% by weight, about 8% by weight, about 10% by weight, about 15% by weight, about 20% by weight, about 25% by weight, about 30% by weight, about 35% by weight, about 40% by weight, or a range between any two of the preceding values of a first non-aqueous solvent. In some aspects, the liquid composition comprises about 15% of a first non-aqueous solvent.

In some aspects, the second non-aqueous solvent is selected from the group consisting of ethylene glycol, glycerin, propylene glycol, ethanol, dipropylene glycol, and tripropylene glycol methyl ether. In some aspects, the second non-aqueous solvent is propylene glycol. In some aspects, the liquid composition does not contain a second non-aqueous solvent.

In some aspects, the liquid composition comprises from about 0% by weight to about 30% by weight of a second non-aqueous solvent. In some aspects, the liquid composition comprises from about 0% by weight to about 20% by weight of a second non-aqueous solvent. In some aspects, the liquid composition comprises from about 0% by weight to about 15% by weight of a second non-aqueous solvent. In some aspects, the liquid composition comprises from about 1% by weight to about 15% by weight of a second non-aqueous solvent. In some aspects, the liquid composition comprises from about 2% by weight to about 15% by weight of a second non-aqueous solvent. In some aspects, the liquid composition comprises from about 3% by weight to about 15% by weight of a second non-aqueous solvent. In some aspects, the liquid composition comprises from about 4% by weight to about 15% by weight of a second non-aqueous solvent. In some aspects, the liquid composition comprises from about 5% by weight to about 15% by weight of a second non-aqueous solvent. In some aspects, the liquid composition comprises from about 8% by weight to about 15% by weight of a second non-aqueous solvent. In some aspects, the liquid composition comprises from about 10% by weight to about 15% by weight of a second non-aqueous solvent. In some aspects, the liquid composition comprises from about 12% by weight to about 15% by weight of a second non-aqueous solvent. In some aspects, the liquid composition comprises from about 1% by weight to about 12% by weight of a second non-aqueous solvent. In some aspects, the liquid composition comprises from about 1% by weight to about 10% by weight of a second non-aqueous solvent. In some aspects, the liquid composition comprises from about 1% by weight to about 8% by weight of a second non-aqueous solvent. In some aspects, the liquid composition comprises from about 1% by weight to about 5% by weight of a second non-aqueous solvent. In some aspects, the liquid composition comprises from about 1% by weight to about 4% by weight of a second non-aqueous solvent. In some aspects, the liquid composition comprises from about 1% by weight to about 3% by weight of a second non-aqueous solvent. In some aspects, the liquid composition comprises from about 1% by weight to about 2% by weight of a second non-aqueous solvent. In some aspects, the liquid composition comprises 0% by weight of a second non-aqueous solvent.

In some aspects, the liquid composition comprises about 0% by weight, about 5% by weight, about 10% by weight, about 15% by weight, about 20% by weight, about 25% by weight, about 30% by weight, or a range between any two of the preceding values of a second non-aqueous solvent. In some aspects, the liquid composition comprises about 7.2% of a second non-aqueous solvent.

In some aspects, the liquid composition does not separate into more than one layer for at least 24 hours, or one day, at room temperature. In some aspects, the liquid composition does not separate into more than one layer for at 3 days at room temperature. In some aspects, the liquid composition does not separate into more than one layer for at least one week at room temperature. In some aspects, the liquid composition does not separate into more than one layer for at least two weeks at room temperature. In some aspects, the liquid composition does not separate into more than one layer for about one week at room temperature. In some aspects, the liquid composition does not separate into more than one layer for about two weeks at room temperature.

In some aspects, provided herein is a fabric treatment unit dose product further comprising a second water-soluble compartment enclosing a solid composition. In some aspects, the solid composition is a powder composition. In some aspects, the powder composition is a cleaning composition. In some aspects the cleaning composition comprises one or more surfactants, a bleach, an anti-redeposition polymer, an optical brightener, a fragrance composition, or a combination thereof. In some aspects, the fragrance composition is a scent booster.

All of the references cited above, as well as all references cited herein, are incorporated herein by reference in their entireties.

Any examples provided herein are offered by way of illustration and not by way of limitation.

### EXAMPLES

### Example 1: Unit Dose Product with HASE Polymer and Triethanolamine

Exemplary fabric treatment unit dose products as disclosed herein comprise at least one water-soluble compartment enclosing a liquid composition. The liquid composition was prepared by mixing the non-aqueous solvent(s) first, then adding the encapsulated slurry, followed by adding the HASE polymer and Triethanolamine. A reference formulation and a liquid composition as disclosed herein (Composition 1) were prepared with the ingredients and amounts as listed in Table 1 below.

TABLE 1
Formulations of reference and inventive samples

| % wt. in Formula | Reference | Composition 1 |
|---|---|---|
| Glycerin | 17 | 15 |
| PEG400 | 35 | 35 |
| Propylene glycol | 8 | 7.2 |
| Encapsulated Fragrance | 40 | 40 |
| HASE polymer | 0 | 2 |
| Triethanolamine | 0 | 0.8 |

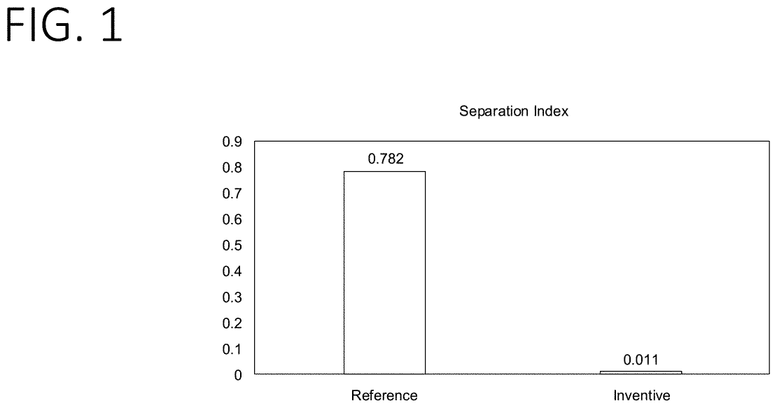

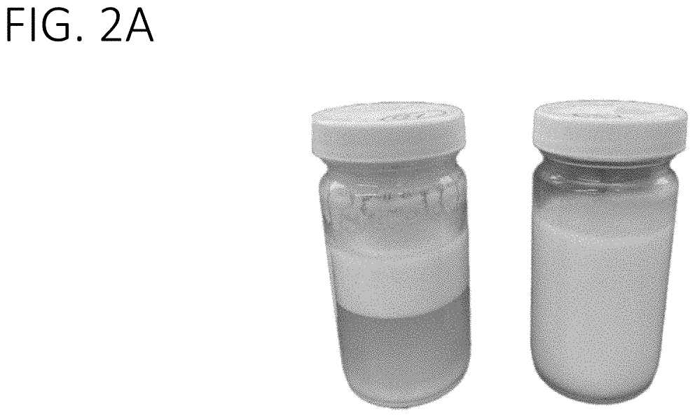

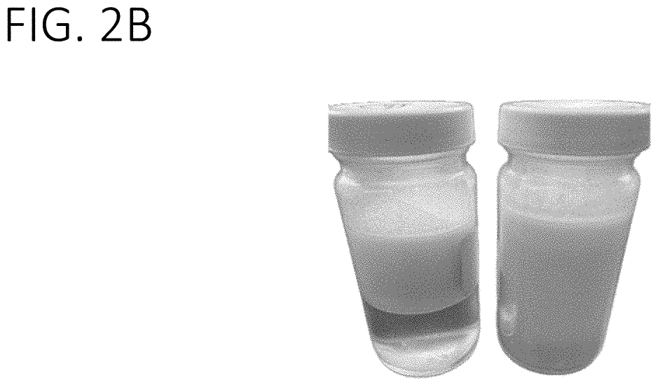

Lumisizer tests were performed to measure the stability of Composition 1 as compared to the reference formulation. The Lumisizer was run at 2000 rpm for 3000 seconds. The separation index value was an indication of the phase separation tendency. The result showed that Composition 1 has a much lower separation index compared with the reference formula (FIG. 1), where smaller separation index value represented a higher stability level. The two samples were aged at room temperature (FIG. 2A) and 40° C. (FIG. 2B) for 2 weeks. Composition 1 (right) with 2% HASE polymer and 0.8% TEA had much less phase separation as compared to the reference formulation (left) without a rheology modifier.

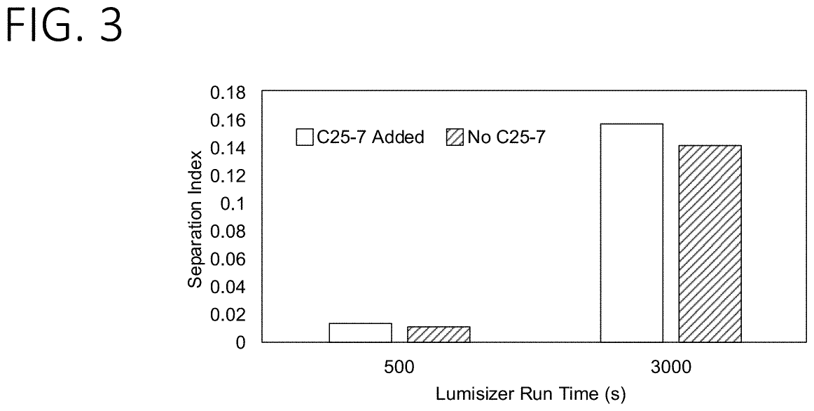

The effect of surfactant addition to the formulation and the resulting liquid stability was analyzed (FIG. 3). Stability was measured via the separation index as measured by a Lumisizer test at 500 seconds or 3000 seconds in formulations with or without alcohol ethoxylate surfactant (C25-7). The Lumisizer results showed that the alcohol ethoxylate did not have any significant impact to the stability. Therefore, it was determined that alcohol ethoxylate was not necessary for this liquid composition.

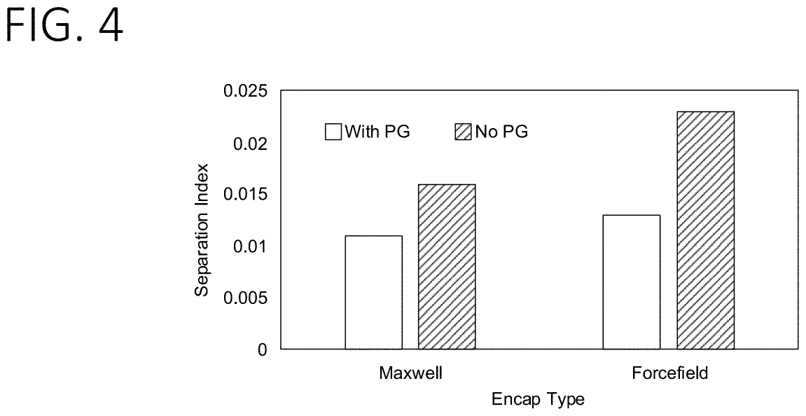

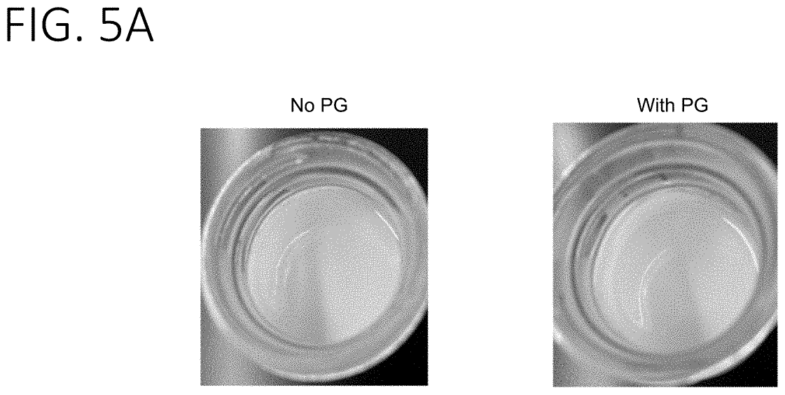

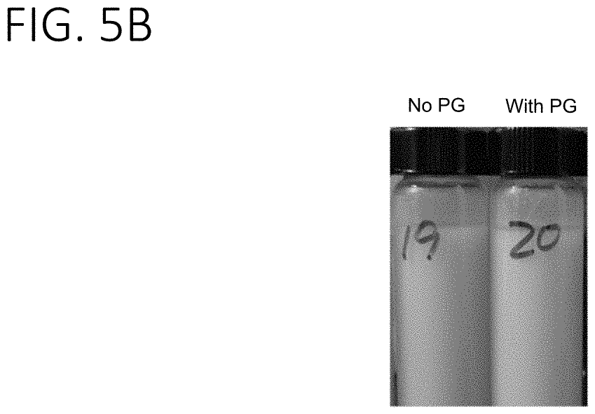

The effect of propylene glycol addition was also analyzed (FIG. 4 and FIG. 5). The Lumisizer result showed that the addition of propylene glycol to the formulations listed in Table 2 below improved the liquid stability for two different encapsulated fragrances (Maxwell and Forcefield).

TABLE 2
FIG. 4 formulations without propylene glycol

| % wt. in Formula | Maxwell | Forcefield |
|---|---|---|
| Glycerin | 17.2 | 23.9 |
| PEG400 | 40 | 40 |
| Encapsulated Fragrance | 40 | 33.3 |
| HASE polymer | 2 | 2 |
| Triethanolamine | 0.8 | 0.8 |

Furthermore, the addition of propylene glycol improved the smoothness texture of liquid. As shown in FIG. 5, the surface of liquid was smoother and there were less streaks on the glass wall when propylene glycol is added. Therefore, propylene glycol was found to optimize stability and appearance of the liquid compositions as disclosed herein.

What is claimed is:

1. A fabric treatment unit dose product comprising:
a. at least one water-soluble compartment enclosing a liquid composition; wherein the liquid composition comprises:
i. from about 10% by weight to about 70% by weight of an encapsulated fragrance slurry;
ii. from about 0.15% by weight to about 1.2% by weight of a rheology modifier;
iii. from about 0.1% by weight to about 3% by weight of a pH adjusting agent;
iv. from about 5% by weight to about 40% by weight of a first non-aqueous solvent;
v. from about 0% by weight to about 20% by weight of a second non-aqueous solvent; and
vi. from about 10% by weight to about 60% by weight of a polyethylene glycol, wherein the polyethylene glycol has a molecular weight between about 200 and about 1000 Daltons.

2. The fabric treatment unit dose product of claim 1, wherein the rheology modifier is an acrylic copolymer, an Alkali Soluble Emulsion (ASE) or a Hydrophobically Modified Alkali Soluble Emulsion (HASE) polymer.

3. The fabric treatment unit dose product of claim 1, wherein the polyethylene glycol has a molecular weight of about 400 Daltons.

4. The fabric treatment unit dose product of claim 1, wherein the pH adjusting agent is selected from the group consisting of triethanolamine, monoethanolamine, tromethamine, sodium carbonate, sodium bicarbonate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), and tetrasodium glutamate diacetate (GLDA).

5. The fabric treatment unit dose product of claim 4, wherein the pH adjusting agent is triethanolamine.

6. The fabric treatment unit dose product of claim 1, wherein the first non-aqueous solvent is selected from the group consisting of ethylene glycol, glycerin, ethanol, dipropylene glycol, and tripropylene glycol methyl ether; and wherein the second non-aqueous solvent is propylene glycol.

7. A liquid composition comprising:
a. from about 10% by weight to about 70% by weight of an encapsulated fragrance slurry;
b. from about 0.15% by weight to about 1.2% by weight of an rheology modifier;
c. from about 0.1% by weight to about 3% by weight of a pH adjusting agent;
d. from about 5% by weight to about 40% by weight of a first non-aqueous solvent;
e. from about 0% by weight to about 20% by weight of a second non-aqueous solvent; and
f. from about 10% by weight to about 60% by weight of a polyethylene glycol, wherein the polyethylene glycol has a molecular weight between about 200 and about 1000 Daltons.

8. The liquid composition of claim 7, wherein the rheology modifier is an Alkali Soluble Emulsion (ASE) or a Hydrophobically Modified Alkali Soluble Emulsion (HASE) polymer.

9. The liquid composition of claim 7, wherein the polyethylene glycol has a molecular weight of about 400 Daltons.

10. The liquid composition of claim 7, wherein the pH adjusting agent is selected from the group consisting of triethanolamine, monoethanolamine, tromethamine, sodium carbonate, sodium bicarbonate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), and tetrasodium glutamate diacetate (GLDA).

11. The liquid composition of claim 7, wherein the pH adjusting agent is triethanolamine.

12. The liquid composition of claim 7, wherein the first non-aqueous solvent is selected from the group consisting of ethylene glycol, glycerin, ethanol, dipropylene glycol, and tripropylene glycol methyl ether.

13. The liquid composition of claim 7, wherein the second non-aqueous solvent is propylene glycol.

14. The liquid composition of claim 7, wherein the liquid composition does not separate into more than one layer for at least one week at room temperature.

15. A fabric treatment unit dose product comprising:
a. at least one water-soluble compartment enclosing a liquid composition; wherein the liquid composition comprises:
i. from about 10% by weight to about 70% by weight of an encapsulated fragrance slurry;
ii. from about 0.15% by weight to about 1.2% by weight of a rheology modifier;
iii. from about 0.1% by weight to about 3% by weight of a pH adjusting agent;
iv. from about 5% by weight to about 40% by weight of a first non-aqueous solvent;
v. from about 1% by weight to about 20% by weight of a second non-aqueous solvent; and
vi. from about 10% by weight to about 60% by weight of a polyethylene glycol, wherein the polyethylene glycol has a molecular weight between about 200 and about 1000 Daltons.

16. The fabric treatment unit dose product of claim 15, wherein the rheology modifier is an Alkali Soluble Emulsion (ASE) or a Hydrophobically Modified Alkali Soluble Emulsion (HASE) polymer.

17. The fabric treatment unit dose product of claim 15, wherein the polyethylene glycol has a molecular weight of about 400 Daltons.

18. The fabric treatment unit dose product of claim 15, wherein the pH adjusting agent is selected from the group consisting of triethanolamine, monoethanolamine, tromethamine, sodium carbonate, sodium bicarbonate, sodium borate, diethylenetriaminepentaacetic acid (DTPA), ethylenediaminetetraacetic acid (EDTA), methylglycinediacetic acid (MGDA), iminodisuccinic acid (IDS), ethylenediamine-N,N′-disuccinic acid (EDDS), and tetrasodium glutamate diacetate (GLDA).

19. The fabric treatment unit dose product of claim 17, wherein the pH adjusting agent is triethanolamine.

20. The fabric treatment unit dose product of claim 15, wherein the first non-aqueous solvent is selected from the group consisting of ethylene glycol, glycerin, ethanol, dipropylene glycol, and tripropylene glycol methyl ether; and wherein the second non-aqueous solvent is propylene glycol.
